(19) United States
(12) Patent Application Publication
(10) Pub. No.: US 2002/0072391 A1
(43) Pub. Date: Jun. 13, 2002

(54) Communication adapter and connection selection method

(75) Inventors: Kishiko Itoh, Tokyo (JP); Masahiko Hatori, Ebina-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/954,937

(22) Filed: Sep. 18, 2001

(30) Foreign Application Priority Data
Dec. 11, 2000 (JP) 2000-376636

(51) Int. Cl. H04M 1/00

(52) U.S. Cl. 455/557; 455/550

(57) ABSTRACT

A computer apparatus in which a plurality of communication adapters 20 (20-1 to 20-4) are installed and which communicates with an external entity through the plurality of communication adapters 20 is provided. The computer includes a utility 11 for controlling the enable/disable of the communication adapters 20 and an NDIS 18 for exchanging data between the utility and the communication adapters 20. The utility 11 inquires of the NDIS 18 to obtain the number and type of available communication adapters 20 and provides a suspend event to the NDIS 18 if a communication adapter 20 to be enabled is not enabled previously or provides a resume event to the NDIS 18 if the communication adapter 20 to be enabled is enabled and requested to be disabled.

### BACKGROUND OF THE INVENTION

1. Field of the Invention

The present invention relates to an interface method for connecting a computer apparatus to a network and more particularly to an interface method allowing an interface device connected to a network to be selected dynamically.

2. Description of the Related Art

A computer apparatus, such as a notebook personal computer (notebook PC), can be connected to a Local Area Network (LAN) through an interface device such as a Network Interface Card (NIC) or the LAN adapter. Today the dominating interface device is a wired communication adapter such as a Token-Ring adapter and Ethernet adapter. However, a wireless LAN adapter may likely receive heightened attention or use in the future. The LAN adapter transmits and intercepts a command and communicates data to and from driver software such as the NDIS (Network Driver Interface Specification) or ODI (Open Datalink Interface) drivers. These drives confirm different specifications depending on an OS environment used and can control a LAN adapter under the control of the OS.

A wired communication adapter, such as a Token-Ring or Ethernet adapter, for connecting a computer to a LAN segment through a cable is used with today's system. In the future, a wireless card, that is, a wireless LAN adapter for the connection to the LAN segment through an access point without the use of cables, will be introduced, as mentioned earlier. In such a case, a first communication adapter may be connected to a given LAN segment through an access point by wireless and a second communication adapter may be connected to the same LAN segment through a cable. Also, they may be connected to separate LAN segments.

A user may want to switch the connection from wireless to wired if, for example, radio wave energy is very low or the user carrying a notebook PC returns to his/her desk where a wired connection is available. In particular, for the notebook PC, which provides high portability, he/she usually may connect the PC to a LAN by wireless while the user is off the desk and may want to use a wired connection, which enables a stable data without being affected by the condition of a radio wave when he/she is at the desk.

As described above, although a PC can be connected to one LAN segment by using one of two communication adapters, it is impossible to dynamically switch from one adapter to the other while one is active, such as by automatically switching between them, in a conventional OS environment. Which communication adapter is used to connect to which network is determined by numbers internally assigned by the OS. For example, although a conventional OS allows a connection through one communication adapter to be selected if a connection through the other communication adapter is not available, it does not permit flexible selection according to circumstances despite of an intense demand for it.

In addition, there is an intense demand for the power savings of a notebook PC. However, active adapters for connecting the PC to a LAN segment consume power even when not all of them are used. If one of them could be selected and the other could be disabled, then the waste of the power could be eliminated, achieving power savings.

Many models of notebook PCs support a docking station (dock). The docking station is an expansion unit for notebook PC and has a housing that serves as a base for the notebook PC and contains a CD-ROM drive, floppy-disk drive, expansion slots, and other components. A configuration may be considered in which one of communication adapters is supported by the docking station and the other adapter is provided in the main unit of the notebook PC. The docking station is often used on a desktop. Users want to use a wireless LAN while they are off their desk and use a communication adapter provided in the docking station to connect to a LAN segment while they are at their desk. However, the demands have not been met because there is no switching capability for this at present.

### SUMMARY OF THE INVENTION

The present invention has been made to solve these technical problems and it is an object of the present invention to provide, in a portable information device or computer apparatus such as a notebook PC, a user interface that allows an entity to which the information device or computer apparatus is connected to for the current communication to be selected.

It is another object of the present invention to achieve power savings in a computer apparatus having a plurality of interface devices providing a connection to an external entity such as a network.

It is yet another object of the present invention to improve user convenience in connecting a portable information device such as a notebook PC to a network when the device is connected to a docking station.

To achieve these objects, the present invention enables a dynamic selection of a Network Interface Card (NIC), for example, by using a power management event. The NIC can be connected by priority to an expansion unit such as a docking station by providing a default priority setting. Enabling/disabling of the NIC can be automatically/dynamically. For example, a wireless LAN may be used before a notebook PC is connected to the docking station and a wired LAN may be used after the notebook PC is connected to the docking station. That is, the present invention provides a communication adapter selection method for selecting a given communication adapter in a system environment in which a plurality of communication adapters are installed in a computer apparatus to communicate with an external entity, comprising the steps of: storing information for identifying among the plurality of communication adapters a communication adapter specified by a user as a communication adapter to be enabled; determining whether the plurality of communication adapters installed in the system are available or not; enabling the communication adapter specified by the user if it is determined that the communication adapter specified by the user is available; and disabling, among communication adapters determined to be available, communication adapters other than the enabled communication adapter.

The adapter selection method to which the present invention is applied comprises the steps of: receiving an input event for identifying among the plurality of communication adapters installed in the system a communication adapter specified by a user as an adapter to be enabled; and in response to the input event, enabling the communication adapter specified by the user and disabling a communication adapter that is enabled before the input event is received. This configuration is preferable in that the setting for communication adapter can be changed in response to a change operation by the user.

In addition, the communication adapter selection method to which the present invention is applied may further comprise the number of communication adapters required by a user is stored; the priorities assigned to set up communication adapters are stored; a given communication adapter among said plurality of communication adapters is enabled based on said stored number of the communication adapters and said stored priorities; and the communication adapters other than said enabled communication adapter are disabled. The stored number of the communication adapters may be one, that is, one communication adapter is set to as the communication adapter to be enabled. Alternatively, more than one communication adapters may be set as communication adapters to be enabled.

The communication adapter selection method to which the present invention is applied comprises the steps of: pre-registering information about a communication adapter to be enabled in response to a predetermined condition of an operating environment of the computer apparatus; detecting event information generated by a change in the operating environment of the computer apparatus; analyzing the event information to determine whether the event information meets the predetermined condition of the operating environment or not; and, if the event information meets the predetermined condition of the operation environment, enabling a communication adapter to be enabled in response to the predetermined condition of the operating environment. Examples of the event information generated by a change in the operating environment include the attachment/detachment of the computer apparatus to/from a docking station, the attachment/detachment of a LAN card to/from the computer apparatus, and the depression of a predetermined key.

The present invention also provides a communication adapter selection method for enabling a given communication adapter in a system environment comprising communication adapters installed in a portable information device, such as a notebook PC, and a communication adapter installed in an expansion unit, such as a docking station, attachable to the portable information device, comprising the steps of: reading priority information in which a priority assigned to a communication adapter constituting the system is set from a profile; determining whether all the communication adapters configured in the system are available or not; if it is determined that the communication adapter installed in the expansion unit is available and the read priority information indicates that the priority of the communication adapter installed in the expansion unit is higher than the priority of the communication adapters installed in the portable information device, enabling the communication adapter installed in the expansion unit and disabling the communication adapters installed in the portable information device. At least one of the communication adapters installed in the portable information device is a wireless LAN adapter and the priority of the wireless LAN adapter set in said read priority information is immediately below the priority of the communication adapter installed in the expansion unit. This configuration is preferable in that wireless communication is performed by using a higher-priority wireless LAN adapter when the portable information device is not connected to an expansion unit such as a docking station, and a communication adapter installed in the expansion unit that provides better communication conditions can be selected to perform communication if the device is not connected to the expansion unit.

The adapter selection method to which the present invention is applied comprises reading information about the configuration of a communication adapter configured in a system from a profile; setting a location where the system performs communication; setting a default priority assigned to a communication adapter to be enabled; setting the number of communication adapters to be enabled; and storing in a profile the default priority and the number of the communication adapters to be enabled for each of the set locations.

The default priority determines the order in which the communication adapters are enabled when the communication adapters among the communication adapters configured in the system are inserted into the system and opened. This configuration is advantageous in that a communication adapter suitable for each location where a notebook PC is used can be selected and the selected adapter can be enabled in the location selected by the user.

The present invention also provide a computer apparatus for selecting a given communication adapter in a system environment in which a plurality of communication adapters are installed to communicate with an external entity, the computer apparatus comprising: information storage for storing information identifying among the plurality of communication adapters installed in the system a communication adapter specified by a user as a communication adapter to be enabled; determination means for determining whether the plurality of communication adapters installed in the system are available and; setting means for enabling, among communication adapters determined to be available by the determination means, the communication adapter specified by the user as the communication adapter to be enabled in the information storage.

The computer apparatus further comprises adapter count storage for storing the number of communication adapters to be enabled and the setting means enables as may communication adapters as the number of the adapters stored in the adapter count storage, in descending order of priority. This configuration is preferable in that power consumption can be reduced by, for example, stopping power supply to disabled adapters.

Furthermore, display means may be provided for indicating the plurality of communication adapters installed in the computer apparatus, displaying whether the communication adapters are enabled or disabled and/or information stored in the information storage. This configuration is advantageous in that the user can check the settings and priorities for the adapters and can easily switch over to a communication adapter to be selected.

The computer apparatus to which the present invention is applied comprises input event receiving means for receiving an input event for identifying among the plurality of communication adapters installed in the system a communication adapter specified by a user as an adapter to be enabled; and a setting means for, in response to the input event, enabling the communication adapter specified by the user and disabling a communication adapter that is enabled before the input event is received.

Viewing from another point, the present invention provides a computer apparatus in which a plurality of communication adapters such as a NIC are installed, the computer apparatus communicating with an external entity through the plurality of communication adapters and comprising: a utility for controlling the enable/disable of the communication adapters; and a driver such as NDIS for exchanging data between the utility and the communication adapter; wherein the utility provides a suspend (a mode that stops operations and shuts down power supply while maintaining the execution status of a program after no input is received for a predetermined period of time) event to the driver if a communication adapter to be enabled is not enabled previously or provides a resume (a mode that saves the status of an operation immediately before shut-down so that the operation can be restarted from the point at which the operation is interrupted when the power is supplied subsequently) event to the driver if the communication adapter to be enabled is enabled and requested to be disabled.

The present invention also provides a portable information device in which a plurality of communication adapters are installed and which can be connected with a expansion unit in which a given communication adapter is installed, the portable information terminal comprising: storage for storing priority information indicating the order in which the communication adapters are enabled as information varying from location to location where the portable information device is used; connection recognition means recognizing the connection of the expansion unit; an open-operation execution unit for executing an adapter open operation which is a confirmation whether it is enabled or not on all the communication adapters including the communication adapter installed in the expansion unit when the connection recognition means recognizes the connection; and setting means for enabling a given adapter among communication adapters successfully opened by the open-operation execution means according to the priority information stored in the storage.

The portable information device to which the present invention is applied comprises connection recognition means recognizing the connection of the expansion means; and priority connection means for connecting the communication adapter installed in the expansion unit in preference to the other communication adapters if the connection recognition means recognizes the connection of the expansion unit. The portable information device further comprises disabling means for, when the priority connection means connects the communication adapter installed in the expansion unit in preference to the other communication adapters, disabling the other communication adapters installed in the portable information device.

The present invention also provides a storage medium storing a program to be executed by a computer so that the computer can execute the program, the program causes the computer to perform the processes for: storing information identifying among the plurality of communication adapters installed in the system a communication adapter specified by a user as an adapter to be enabled; determining whether the plurality of communication adapters installed in the system is available; and enabling the communication adapter specified by the user if the communication adapter specified by the user is available.

The program also causes the computer to perform the processes for: receiving an input event for identifying among the plurality of communication adapters installed in the system a communication adapter specified by a user as an adapter to be enabled; and, in response to the input event, enabling the communication adapter specified by the user and disabling a communication adapter that is enabled before the input event is received.

The storage medium may be a medium such as a CD-ROM and the program may be read by a CD-ROM reading apparatus, stored in a hard disk in the computer, for example, and executed by the computer.

### BRIEF DESCRIPTION OF THE DRAWINGS

FIG. 1 is a diagram for illustrating a general configuration of a network connection system to which the present invention is applied;

FIG. 2 is a block diagram of a general configuration of the system 10 shown in FIG. 1 provided in a Windows environment;

FIG. 3 shows a process flow for dynamically selecting a communication adapter 20 to be used, during the load of an OS (during the load of the utility 11);

FIG. 4 shows a process flow for dynamically selecting a communication adapter 20 to be used, during the execution of an OS;

FIG. 5 shows a process flow when the system is connected with a docking station;

FIG. 6 shows a process flow for setting and updating default information;

FIG. 7 shows a flowchart of a process performed in response to an event;

FIG. 8 shows the user interface for displaying a status and options;

FIG. 9 shows a user interface for prioritizing communication adapters 20 to be enabled; and

FIG. 10 user interface for setting locations and default values.

### DETAILED DESCRIPTION

An embodiment of the present invention will be described in detail below with respect to the accompanying drawings.

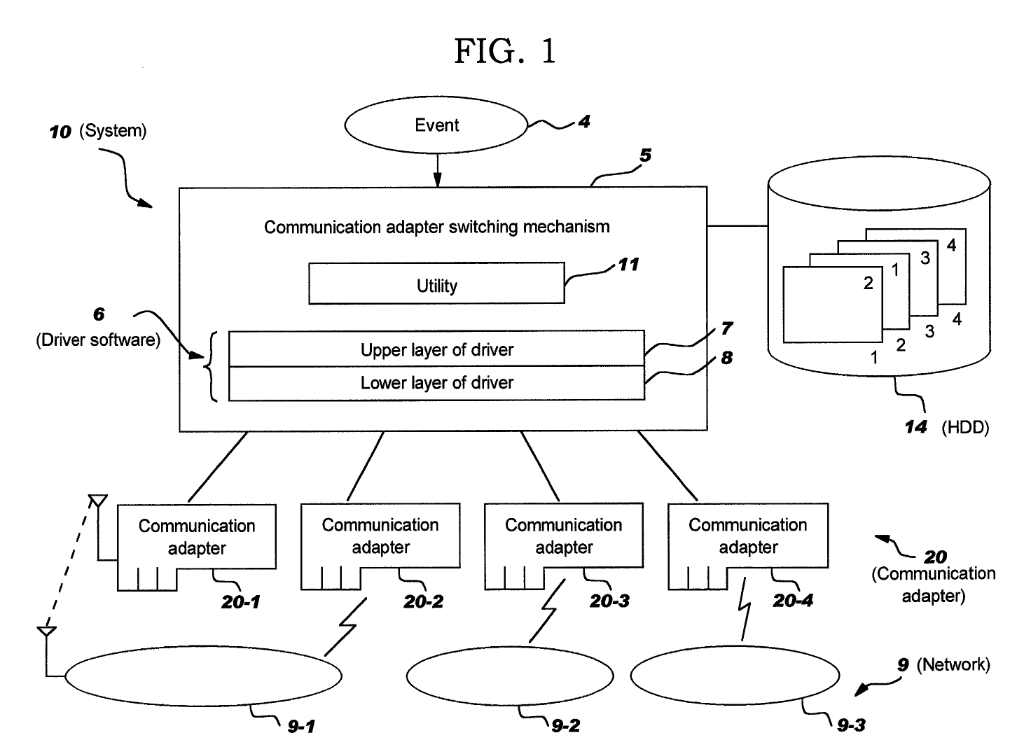

FIG. 1 is a diagram for illustrating a general configuration of a network connection system to which the present embodiment is applied. A notebook PC (not shown) is connected to a network 9 (9-1 to 9-3) consisting of LAN segments through a communication adapter 20 (20-1 to 20-4). The notebook PC includes a system 10 for selecting one of communication adapters 20 (20-1 to 20-4). This system 10 comprises a communication adapter switching mechanism 5 and a hard disk drive (HDD) 14, which is a storage device for storing information about the configuration of the communication adapter 20, and a switching operation is performed according to an event 4 corresponding to a change operation by a user. The communication adapter switching mechanism 5 comprises a utility 11 for controlling enable/disable of the communication adapter 20 and driver software 6 for using the communication adapter 20. The driver software 6 consists of an upper layer 7 and lower layer 8.

The communication adapter 20 can use a NIC (Network Interface Card), for example, as a LAN connection board, which is an interface device. The communication adapter 20 using the NIC is attached to an expansion slot (bus) of a computer apparatus to connect a LAN cable to it and is controlled by the driver software 6 to perform data transfer. Basic configuration of the communication adapter 20 is an interface for connecting to an expansion bus of the computer apparatus, a controller for performing access control, and an interface for connecting to a network medium. Different boards are used depending on the type of the expansion bus such as ISA, PCI, or C bus.

In the example shown in FIG. 1, the communication adapter 20-1 is a wireless card, that is, a connection board (LAN connection board) for connecting the computer apparatus to the network 9-1 through an access point without using a cable. The communication adapters 20-2 to 20-4 are wired cards, that is, connection boards (LAN connection boards) for connecting the computer apparatus to the networks 9-1 to 9-3 through a cable. The communication adapters 20-1 and 20-2 are configured so as to be capable of being connected to the same network, 9-1. According to the present embodiment, only a communication adapter, adapter 20-1, for example, which is selected beforehand, is dynamically enabled and the other adapters, 20-2 to 20-4, are dynamically disabled. The communication adapter 20 may be a board supporting a modem.

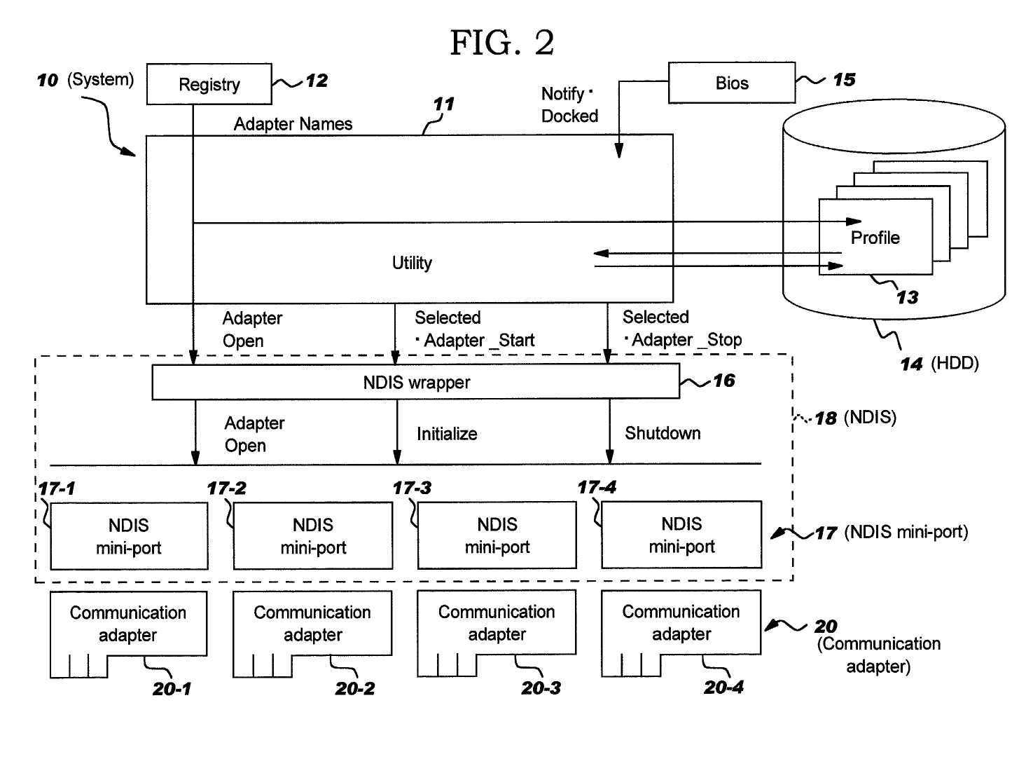

FIG. 2 is a block diagram showing a general configuration of the system 10 shown in FIG. 1, implemented in a Windows environment. The system 10 comprises a registry 12 for providing adapter configuration information for the HDD 14 of the utility 11. The HDD 14, which is a storage device, contains a profile 13 for maintaining information about the communication adapter 20 that is successfully opened. The system 10 also comprises a BIOS (Basic Input/Output system) 15, which determines whether the docking station as an expansion unit is connected or not, whether a LAN card and an AC power supply is attached or not, and whether a given key is depressed or not. The profile 13 stored in the HDD 14 contains communication adapter 20 configuration information about at least locations that are sites connected to a network by users. For example, the user of a notebook PC with high portability may want to connect the PC to the network 9 from a place such as an American corporation during a business trip, for example, besides the home base in Japan. According to the present embodiment, different items of information about the configuration of the communication adapter 20 are provided as the profile 13 for different locations (environments) so that these items of information can be stored on a location-by-location basis. This allows an adapter most suitable for the location chosen by the user to be selected, improving usability for the user.

The system 10 also comprises as the driver software 6 a NDIS (Network Driver Interface Specification) 18 (NDSI is an interface specification proposed by Microsoft Corporation), which is a driver for NIC. The NDIS 18 consists of a NDIS wrapper 16, which is a driver management program as the upper layer 7 of the driver and a NDIS mini-port 17 (17-1 to 17-4), which is the lower layer 8 of a driver. The NDIS wrapper 16 calls the NDIS mini-port 17 to read a handler. The communication adapters 20-1 to 20-4 are inserted to the NDIS mini-port 17-1 to 17-4.

The utility 11 has a user interface and an internal logic. In the utility 11, the registry 12 is referenced to retrieve an adapter name to find an communication adapter 20 installed, then an Adapter Open operation is executed. For example, when an OS such as Windows (“Windows” is a trade mark of Microsoft Corporation) is loaded, when an event indicating the connection of the docking station is provided from the BIOS 15, or when a window for the utility 11 is selected, the Adapter Open operation is executed. Then, the number of available communication adapters 20 is determined and the communication adapters 20 are enabled or disabled by using default priorities. Adapter_Start is provided to the NDIS wrapper 16 for an communication adapter to be enabled and Adapter_Stop is provided to the NDSI wrapper 16 for communication adapters 20 to be disabled. Adapter Open, Initialize, Shutdown are output from the NDIS wrapper 16 to the NDIS mini-port 17.

As the internal logics, a suspend logic and a resume logic of APM (Advanced Power Management), which is a specification for power conservation, are applied. The suspend is a feature that temporarily halts operations with the execution state of a program being maintained and shuts down a device after no input is provided for a predetermined period of time. The resume is a feature that maintains the sate of a task immediately before a shutdown so that the task can be resumed at the point of interruption when the device is turned on the next time. The utility 11 inquires of the NDSI wrapper 16 to obtain the number and types of communication adapters 20 that is present in order to control the enable/disable of the communication adapters 20. The user interface of the utility 11 provides a suspend event to the NDIS wrapper 16 if a communication adapter 20 to be enabled has not been enabled previously. It provides a resume event to the NDIS wrapper 16 for a communication adapter 20 that is currently enabled and to be disabled. The NDIS wrapper 16 calls the shutdown of the NDIS mini-port 17 if it receives the suspend or calls the initialization of the NDIS mini-port 17 if it receives the resume, thereby allowing the communication adapter 20 to be enabled/disabled. Because resources are released in a PC card by the suspend, a ReConfig operation is required after the shutdown/initialization.

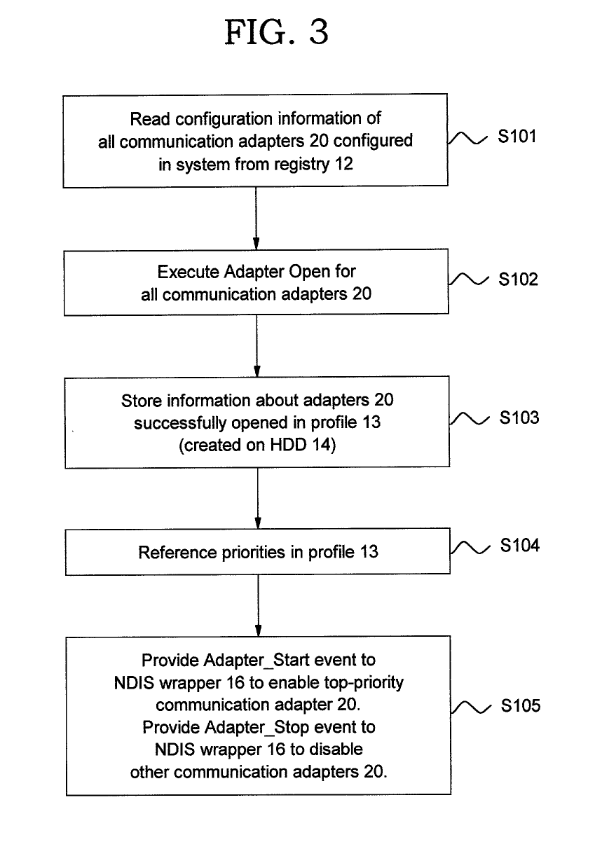

FIG. 3 shows a process flow for dynamically selecting a communication adapter 20 to be used, during the load of an OS (the load of the utility 11). First, the utility 11 reads information about the configuration of all the communication adapters 20 configured in the system from the registry 12 (step 101). Then, it executes an Adapter Open operation for all the communication adapters 20 (step 102). That is, it is determined as to whether the communication adapters 20 are enabled or not. Typically, a device driver must be installed in order to use the communication adapter 20. If the communication adapter 20 is a PC card, determination whether the communication adapter 20 is physically present, such as determination whether it is not detached, should be made. Then, information about the communication adapter 20 that is successfully opened is stored in a profile 13 on an HDD 14 (step 103). The configuration information stored as a profile 13 includes an index, priority, adapter information (including LAN/modem information), and network information (including configuration information concerning TCI/IP) and can be set, added, or modified by a user when the communication adapter is configured/added or any other times. Next, priorities in the profile 13 are referenced (step 104). An Adapter_Start event is provided to the NDIS wrapper 16 in order to enable the top-priority communication adapter 20. An Adapter_Stop event is provided to the NDIS wrapper 16 in order to disable the other communication adapters 20 (step 105). In this way, the communication adapter 20 to be used can be dynamically selected during loading the OS (loading the utility 11).

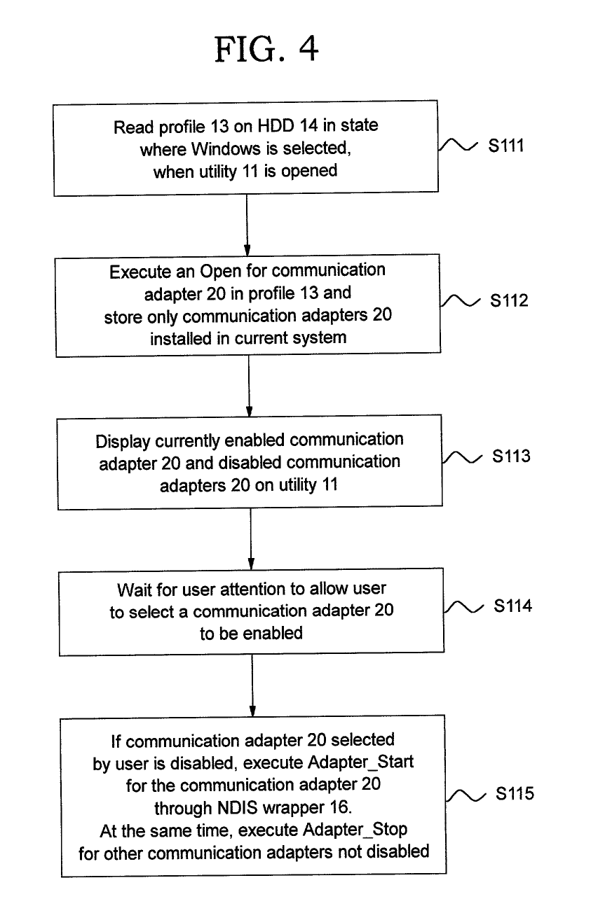

FIG. 4 shows a process flow for dynamically selecting a communication adapter 20 to be used during the execution of an OS. When the utility 11 is opened, it first reads the profile 13 on the HDD 14 in a state where Windows is selected (the window of Windows is on the top of a window stack) (step 111). Then an open operation is performed on communication adapters 20 in the profile 13 and only those communication adapters 20 installed in the current system are stored (step 112). Here, given that a PnP (plug-and-play) device is removed in the meantime, the open operation should be performed once again.

Next, a currently enabled communication adapter 20 and disabled adapters 20 are displayed on the utility 11 (step 113). Then a user attention is waited for to allow the user to select a communication adapter 20 to be enabled (step 114). If the communication adapter 20 selected by the user is disabled, Adapter_start is executed through the NDIS wrapper 16 in order to enable it. At the same time, Adapter_Stop is executed for communication adapters 20 that are not disabled in the other communication adapters 20 in order to disable them (step 115).

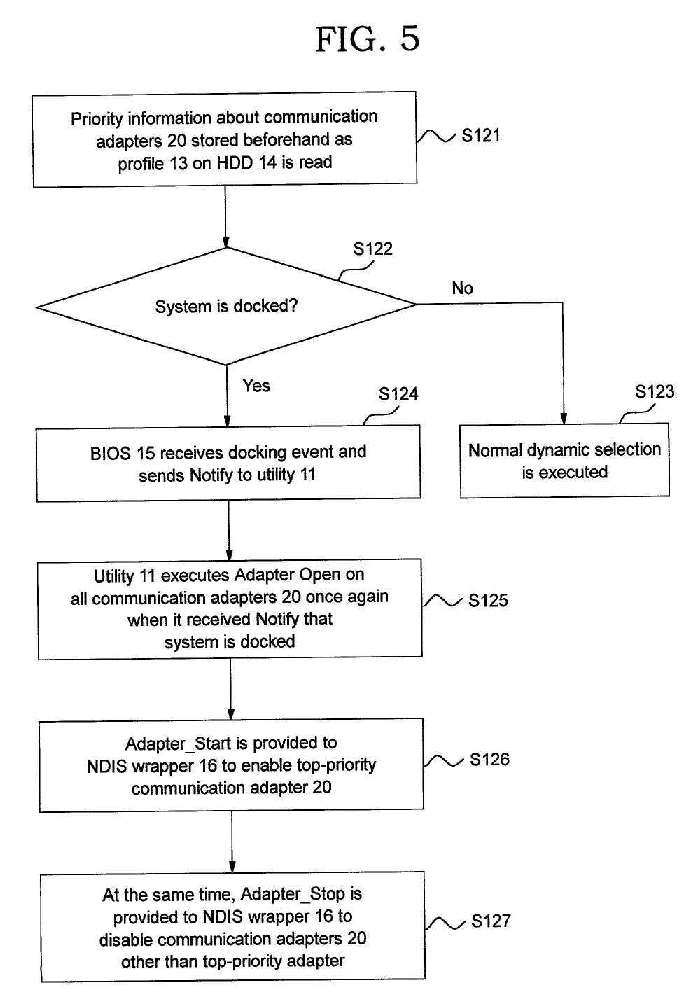

FIG. 5 shows a process flow when the system is connected with a docking station. The flow is a prioritizing logic for enabling a communication adapter 20 in the docking station in preference to other communication adapters 20. First, information about the priority of communication adapters 20 stored in the HDD 14 as a profile 13 is read (step 121). Here, the priority is specified by the user. The communication adapter 20 in the docking station may be enabled in preference to the others during the docking by pre-assigning by the user a high priority to the communication adapter 20 installed in the docking station. Then it is determined whether the system is docked in the docking station (step 122). If it is not docked, the normal dynamic selection as described earlier is executed (step 123).

If it is determined at step 122 that the system is docked, the BIOS 15 receives a docking event and sends Notify to the utility 11 (step 124). When the utility 11 receives the Notify indicating that the system is docked, it executes an Adapter Open operation for all the communication adapters 20 once again (step 125). If the communication adapter 20 is installed in the docking station, the total number of available communication adapters 20 would increase by one. Then Adapter_Start is provided to the NDIS wrapper 16 in order to enable the top-priority communication adapter 20 (step 126). At the same time, Adapter_Stop is provided to the NDIS wrapper 16 in order to disable communication adapters 20 other than the top-quality communication adapter 20. By configuring the system in this way, the communication adapter 20 in the docking station can be enabled in preference to the others by docking the system in the docking station if a high priority is assigned to the communication adapter 20 installed in the docking station.

The default priorities for selecting communication adapters 20 and support for docking is as follows. During hot- or warm docking, a dock configuration (DockConfig) event is received and the Adapter Open operation is executed once again according to the default priorities. If a communication adapter 20 in the docking station is set as the top-priority adapter, the communication adapter 20 in the docking station is enabled and other communication adapters 20 are disabled to connect the system to a network through the communication adapter 20 in the docking station.

While it is assumed that the top-priority communication adapter 20 is enabled and the other adapters are disabled at the same time in the process flows shown in FIGS. 3, 4, and 5, the number of communication adapters 20 enabled at the same time may be determined by default setting. For example, if the default setting is to enable the two highest priority communication adapters 20, the two adapters may be enabled and the others may be disabled.

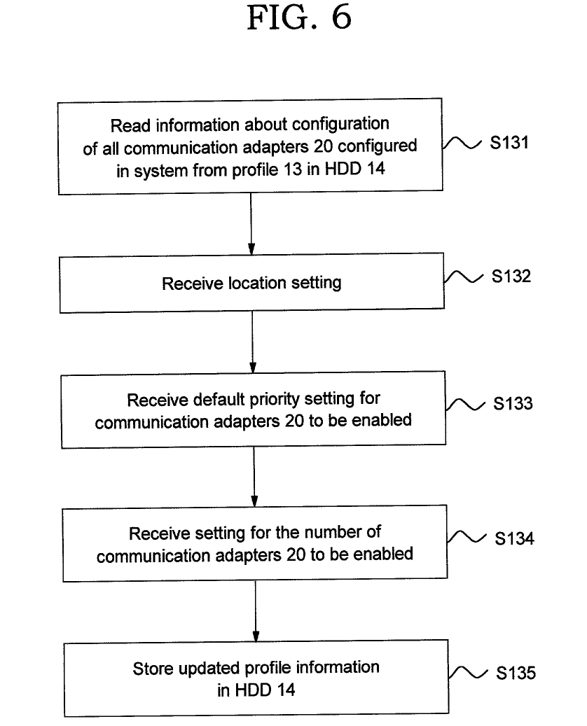

FIG. 6 shows a process flow for setting and updating default information. This default information does not necessarily required to be set. To set or update the defaults, information about the configuration of all the communication adapters 20 configured in the system is first read from a profile 13 stored in an HDD 14 (step 131). Then a location setting is received from a user (step 132). Then settings for default priority of communication adapters 20 to be enabled is received (step 133) and settings for the number of the communication adapters 20 to be enabled is received (step 134). Then the updated profile information is stored in the HDD 14 (step 135) to allow the default information to be set or updated. If the top priority is not assigned to a communication adapter 20 installed in a docking station in the 15 priority setting, the feature for enabling the communication adapter 20 in the docking station in preference to the other adapters during docking would not work.

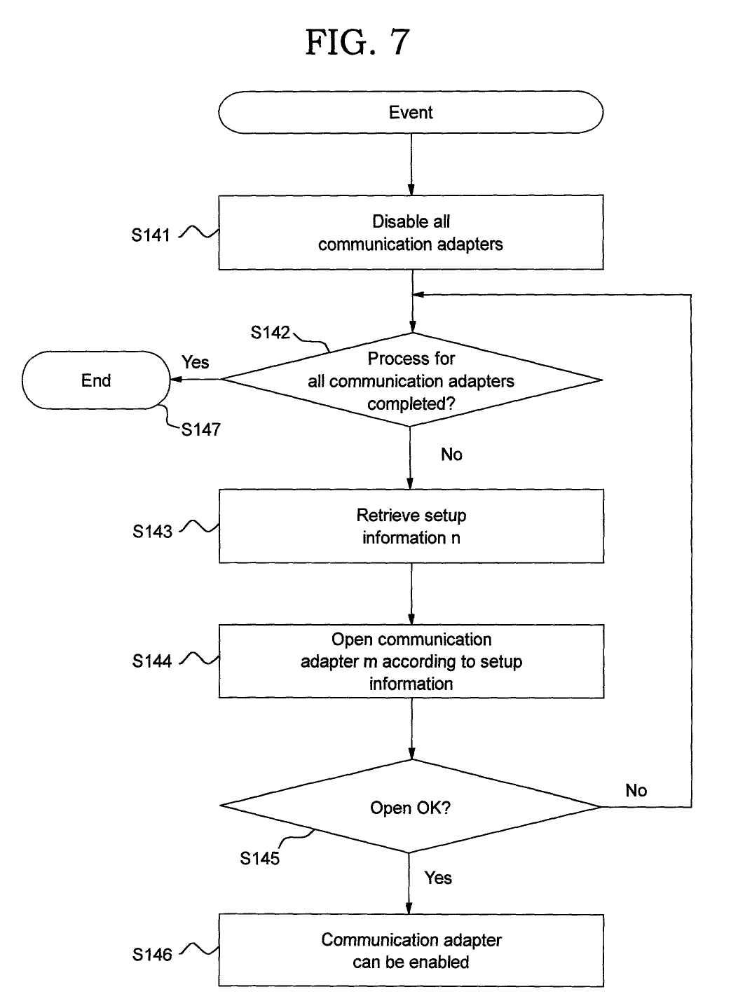

FIG. 7 shows a flowchart of a process performed in response to an event. For example, an event, which is generated when the system is connected to a docking station, when a user annotation that invokes a mechanism (the utility 11, for example) for switching between adapters, or when the wireless communication system moves to out of a coverage area, is received and, in response to an event for creating a communication path that is registered beforehand, all the communication adapters 20 are first disabled (step 141). Then, it is determined whether the process for all the adapters completed or not (step 142). If the process for all the adapters is not completed, setting information n is retrieved from the profile 13 (step 143). Then a relevant communication adapter 20 (communication adapter m) is opened according to the setting information n retrieved (step 144). Then, it is determined whether the adapter is successfully opened or not (step 145) and, if successfully opened, the communication adapter 20 can be enabled (step 146). If not opened, the routine returns to step 142 and it is determined whether the process for all the communication adapter is completed or not. If the process for all the communication adapter is completed, it is assumed that open operations performed on all the adapters registered for Open failed (NG), and therefore the process for the event will end (step 147).

A method for providing a user interface according to the present embodiment will be described below.

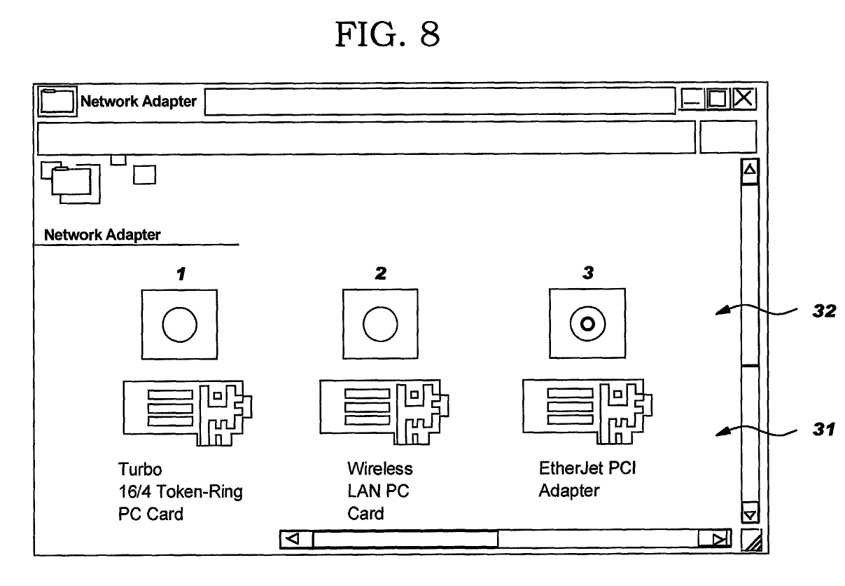

FIG. 8 shows the user interface for displaying a status and options. The screen is displayed on a display of a notebook PC, for example, for enabling or disabling a communication adapter 20. In this example, indicators 32, which are radio buttons for indicating an active communication adapter 20, are displayed along with adapter icons 31, as the user interface for allowing a user to select a communication adapter 20 to be used for the current connection. The adapter icons 31 are labeled with the name of communication adapters 20 installed in the system. In this example, the following three communication adapters 20 are displayed: a Turbo 16/4 Token-ring PC card, which is a wired communication adapter, a wireless LAN PC card, and an Ether Jet PCI adapter, which is a wired communication adapter. Indicators 32 indicate whether communication adapters 20 are currently enabled or disabled. It is indicated that the Ether Jet PCI adapter is currently active. The user can select a desired communication adapter 20 to be enabled by clicking on the section (adapter icon 31 or indicator 32) of the adapter 20 based on the indication of adapter icons 31 and indicators 32. Communication adapters 20 other than the selected one can be disabled at the same time.

That is, the indicators 32 function as a flip-flop. When one of the communication adapters 20 is selected, the communication adapter 20 is enabled and the other communication adapters 20 are automatically disabled. If the user want to use a plurality of communication adapters 20, the user would select another. This can be addressed by leaving enabled a communication adapter 20 selected after the user interface is opened, enabling the next adapter selected, and disabling the other adapters. According to the present embodiment, in a window of another tab which will be described later, a function is provided that enables or disables all the adapters.

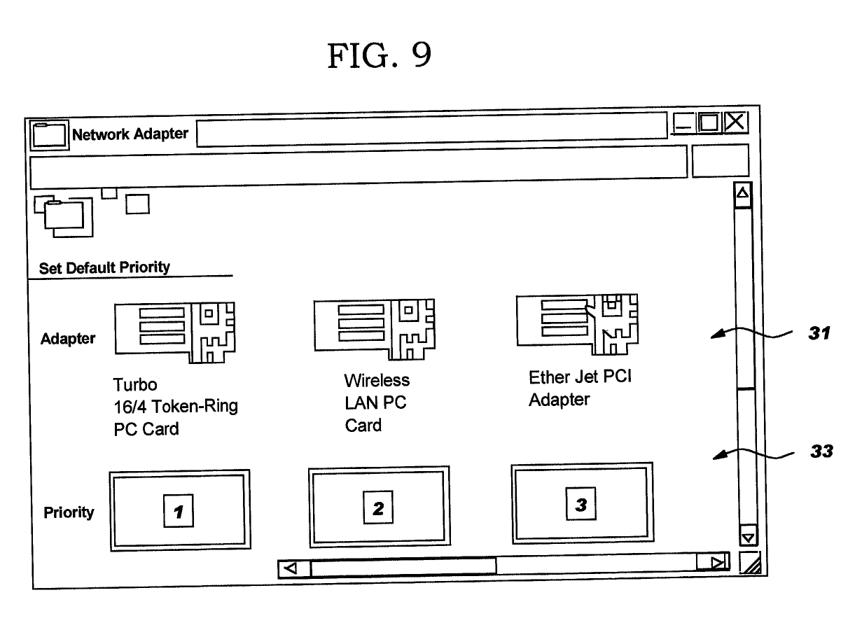

FIG. 9 shows a user interface for prioritizing communication adapters 20 to be enabled and shows information displayed on the display of the notebook PC, for example. The user interface shown in FIG. 9 is for determining the default priorities of communication adapters 20 to be enabled. In this example, priorities 33 are displayed along with the adapter icons 31 described with respect to FIG. 8. If some of communication adapters 20 configured in the system are installed and can be opened, the order in which those communication adapters 20 are enabled is determined in this user interface. In the example shown in FIG. 9, priority levels 1, 2, and 3 are assigned to the communication adapters 20, from left to right. The priorities 33 for the communication adapters 20 can be set by dragging the adapter icons 31 to re-order them. The number, names, set priorities 33 of the communication adapters 20 are stored in an HDD 14 as a profile 13.

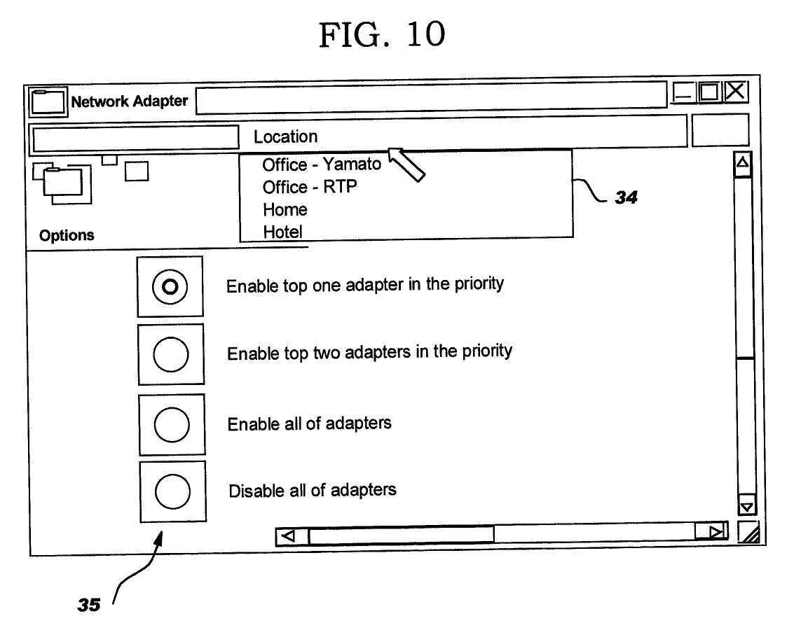

FIG. 10 shows a user interface for setting locations and default values and information displayed on the display of a notebook PC. In the user interface shown in FIG. 10, location information 34 can be set and options 35 can be set for each item of location information 34. Locations such as an office, home, and hotel can be entered as the location information 34. Setting for enabling only one adapter with the highest priority 33 and disabling the others, setting for enabling the two-highest-priority adapters and disabling the others, and setting for enabling all the communication adapters 20, or setting for disabling all the communication adapters can be selected from the options 35, thus allowing the number of communication adapters 20 to be enabled. The user inputs information as the location information 34 using a keyboard and selects one of the options 35 using a pointing device. The specified location information 34 and option 35 are stored in respective profiles 13 created in an HDD 14.

Functions in the present embodiment will be described below with respect to specific examples.

For example, communication adapters 20 are enabled according to the priorities set through the setting user interface shown in FIG. 8, for example. If setting for enabling only the highest-priority adapter and disabling the others is specified through the interface, the communication adapter 20 of priority 1 is enabled and the other communication adapters 30 are disabled. If the communication adapter of the highest priority 33 cannot be opened, a communication adapter 20 of the next highest priority 33 is enabled.

Assuming that an Ether Jet PCI adapter is installed in a docking station, and a wireless LAN PC card and a Turbo 16/4 Token-Ring PC card are installed in a notebook PC. The top-priority (priority 1) is assigned to the Ether Jet PCI adapter card and the second-priority (priority 2) is assigned to the wireless LAN PC card. By setting the priorities in this way, the top-priority Ether Jet PCI adapter is used while the PC is connected to the docking station, and the second-priority wireless LAN PC card is used while it is not connected to the docking station. In addition, the user interface for status indications and options shown in FIG. 8 allows a communication adapter 20 that is not selected to be dynamically selected to temporarily override the current setting. By temporarily overriding the setting, the PC can be explicitly connected to a particular network 9 connected through a particular adapter 20 for a certain period of time.

Furthermore, in most cases, it may be sufficient that a single communication adapter 20 is enabled at a time in a client. However, if different networks 9 (networks 9-2 and 9-3, for example) are accessed through different communication adapters 20 (20-3 and 20-4) as shown in FIG. 1, a user may want to copy data from one network 9 (9-2, for example) to the other network (9-3, for example). In such a case, more then one communication adapters 20 should be enabled. On the other hand, the user may want to enable all the communication adapters 20 to access all of the networks 9 to which the client can be connected, or the user may want to disable all of the communication adapters 20 for power saving. These demands can be met by settings by using the options 35 in the user interface shown in FIG. 10.

Furthermore, assuming that communication adapter 20-1 shown in FIG. 1 is a wireless LAN PC card and communication adapter 20-2 is an Ether Jet PCI adapter, for example. If they access a server on the same network 9-1 as shown in FIG. 1, it may be desired that one of them, whichever can provide connection surely, be used to connect to the server. In such a case, one of the adapters that can be opened may be used to access the server. However, if a Token-Ring PCI adapter and an Ether Jet PCI adapter are installed in one system, it is likely that these communication adapters 20 are installed because a user want to access LANs using these different protocols at the same time. In such a case, both of the Token-ring and Ethernet protocols should be able to be used. The options 35 are provided for meeting such a demand. In addition, if networks using a plurality of different protocols are accessed, both of the two communication adapters 20 should be enabled. The options 35 also can meet such a demand.

A function of a computer apparatus, called “plug-and-play”, is available that allows the functions of a newly connected device to be used first and foremost. According to the present embodiment, if a new communication adapter 20 is added, the communication adapter 20 is set so as to be enabled (operable) unconditionally in order to maintain this “plug-and-play” function. The number of communication adapters 20 currently available is stored in a storage such as an HDD 14 whenever an adapter is opened so that whether a new communication adapter 20 is added or not can be determined.

As described above, according to the present invention, it is possible that only communication adapters selected beforehand are enabled and the other communication adapters 20 are disabled automatically/dynamically. According to a prior art, if a notebook PC is configured to be connected to the same server in an environment where the plurality of communication adapters such as a wireless LAN adapter and a wired Token-Ring or Ethernet adapter are installed in the notebook PC, which communication adapter 20 is being used to communicate with the server cannot be determined. Also, even if the PC is configured to be connected to different servers, which communication adapter 20 is being used to communicate with the server cannot be determined according to the prior art. Furthermore, if a user of the PC wants to access a server using cables even though it is the roaming coverage of a wireless LAN, in view of the reliability of network robustness, conventional network operating systems do not allow such an option. The embodiment of the present invention, on the other hand, one communication adapter 20 can be enabled and the other communication adapters 20 can be disabled at the same time, facilitating the selection of the communication adapter 20 to be used even in mixed environments of wireless and wired systems.

For example, as much as five selection steps were required to enable/disable communication adapters under Windows 95/98. That is, “Control panel”, “System”, “Device manager”, “Network adapter”, and “Enable in this hardware environment”, were to be selected in this order. This is too cumbersome if the enable/disable operation should be performed many times a day. On the other hand, according to the present embodiment, a communication adapter 20 can be selected easily from a user interface showing icons indicating features of communication adapters 20 as shown in FIG. 8.

Furthermore, according to this embodiment, providing the default priority setting allows the communication adapter 20 installed in the docking station to be connected in preference to the other communication adapters, as well as the current connection can be dynamically selected, so that the adapters other than the selected one can be dynamically disabled.

In addition, even if a wired LAN controller does not support a power saving function without cables, power can be saved. Furthermore, when the system is housed in a docking station, a communication adapter 20 in the docking station can be enabled in preference to other communication adapters by providing enable priorities for the plurality of configured communication adapters.

As described above, according to the present invention, a plurality of communication adapters installed in a portable information device or a computer apparatus such as a notebook PC can be dynamically enabled or disabled to use the enabled communication adapter to communicate with an external entity.

What is claimed is:

1. A communication adapter selection method for selecting a given communication adapter in a system environment in which a plurality of communication adapters are installed in a computer apparatus to communicate with an external entity, comprising the steps of:
storing information for identifying among the plurality of communication adapters a communication adapter specified by a user as a communication adapter to be enabled;
determining whether the plurality of communication adapters installed in said system are available or not; and,
enabling said communication adapter specified by the user if it is determined that said communication adapter specified by the user is available.

2. The method according to claim 1, further comprising the step of disabling, among communication adapters determined to be available, communication adapters other than said enabled communication adapter.

3. A communication adapter selection method for selecting a given communication adapter in a system environment in which a plurality of communication adapters are installed in a computer apparatus to communicate with an external entity, comprising the steps of:
receiving an input event for identifying among the plurality of communication adapters installed in the system a communication adapter specified by a user as an adapter to be enabled; and
in response to said input event, enabling said communication adapter specified by the user and disabling a communication adapter that is enabled before said input event is received.

4. A communication adapter selection method for selecting a given communication adapter in a system environment in which a plurality of communication adapters are installed in a computer apparatus, comprising the steps of:
storing the number of communication adapters required by a user;
enabling among said plurality of communication adapters a given communication adapter based on said stored number of the communication adapters; and
disabling communication adapters other than said enabled communication adapter.

5. The method according to claim 4, wherein the priorities assigned to set up communication adapters are stored and the given communication adapter is enabled based on said stored number of the communication adapters and said stored priorities.

6. A communication adapter selection method for selecting a given communication adapter in a system environment in which a plurality of communication adapters are installed in a computer apparatus to communicate with an external entity, comprising the steps of:
pre-registering information about a communication adapter to be enabled in response to a predetermined condition of an operating environment of said computer apparatus;
detecting event information generated by a change in the operating environment of said computer apparatus;
analyzing said event information to determine whether said event information meets said predetermined condition of said operating environment or not; and,
if said event information meets said predetermined condition of said operation environment, enabling a communication adapter to be enabled in response to said predetermined condition of the operating environment.

7. A communication adapter selection method for enabling a given communication adapter in a system environment comprising communication adapters installed in a portable information device and a communication adapter installed in an expansion unit attachable to said portable information device, comprising the steps of:
reading priority information in which a priority assigned to a communication adapter constituting the system is set from a profile;
determining whether all the communication adapters configured in said system are available or not; and,
if it is determined that the communication adapter installed in said expansion unit is available and said read priority information indicates that the priority of said communication adapter installed in said expansion unit is higher than the priority of the communication adapters installed in said portable information device, enabling said communication adapter installed in said expansion unit.

8. The method according to claim 7, wherein said communication adapters installed in said portable information device is disabled if said communication adapter installed in said expansion unit is enabled.

9. The method according to claim 7, wherein at least one of the communication adapters installed in said portable information device is a wireless LAN adapter; and
the priority of said wireless LAN adapter set in said read priority information is immediately below the priority of the communication adapter installed in said expansion unit.

10. A method for setting up a communication adapter comprising the steps of:
reading information about the configuration of a communication adapter configured in a system from a profile;
setting a location where the system performs communication;
setting a default priority assigned to a communication adapter to be enabled;
setting the number of communication adapters to be enabled; and
storing in a profile said default priority and said number of the communication adapters to be enabled for each of said set locations.

11. A computer apparatus for selecting a given communication adapter in a system environment in which a plurality of communication adapters are installed to communicate with an external entity, said computer apparatus comprising:
information storage for storing information identifying among the plurality of communication adapters a communication adapter specified by a user as a communication adapter to be enabled;
a determination unit for determining whether the plurality of communication adapters installed in said system are available and;
a setting unit for enabling, among communication adapters determined to be available by said determination unit, said communication adapter specified by the user as the communication adapter to be enabled in said information storage.

12. The apparatus according to claim 11, wherein said setting unit disables communication adapters other than said given communication adapter enabled.

13. The apparatus according to claim 11 further comprising adapter count storage for storing the number of communication adapters to be enabled, wherein said setting unit enables as may communication adapters as said number of the adapters stored in said adapter count storage, in descending order of priority.

14. A computer apparatus for selecting a given communication adapter in a system environment in which a plurality of communication adapters are installed to communicate with an external entity, said computer apparatus comprising:
an input event receiving unit for receiving an input event for identifying among the plurality of communication adapters installed in the system a communication adapter specified by a user as an adapter to be enabled; and
a setting means for, in response to said input event received by said input event receiving unit, enabling said communication adapter specified by the user and disabling a communication adapter that is enabled before said input event is received.

15. A computer apparatus in which a plurality of communication adapters are installed, said computer apparatus communicating with an external entity through said plurality of communication adapters and comprising:
a utility for controlling the enable/disable of said communication adapters; and
a driver for exchanging data between said utility and said communication adapters;
wherein said utility provides a suspend event to said driver if a communication adapter to be enabled is not enabled previously or provides a resume event to said driver if the communication adapter to be enabled is enabled and requested to be disabled.

16. The apparatus according to claim 15, wherein said utility inquires of said driver to obtain the number and type of existing communication adapters.

17. A portable information device in which a plurality of communication adapters are installed and which can be connected with a expansion unit in which a given communication adapter is installed, said portable information terminal comprising: storage for storing priority information indicating the order in which the communication adapters are enabled;
a connection recognition unit recognizing the connection of said expansion unit;
an open-operation execution unit for executing an adapter open operation on all the communication adapters including said communication adapter installed in said expansion unit when said connection recognition unit recognizes the connection; and
a setting unit for enabling a given communication adapter among communication adapters successfully opened by said open-operation execution unit according to said priority information stored in said storage.

18. The device according to claim 17, wherein said priority information stored in said storage varies from location to location where said portable information device is used.

19. A portable information device in which a plurality of communication adapters are installed and which can be connected with a expansion unit in which a given communication adapter is installed, said portable information device comprising:
a connection recognition unit recognizing the connection of said expansion unit; and
a priority connection unit for connecting said communication adapter installed in said expansion unit in preference to the other communication adapters if said connection recognition unit recognizes the connection of said expansion unit.

20. The device according to claim 19 further comprising a disabling unit for, when said priority connection unit connects said communication adapter installed in said expansion unit in preference to the other communication adapters, disabling said other communication adapters installed in said portable information device.

21. A storage medium storing a program to be executed by a computer so that said computer can read the program, said program causes said computer to perform the processes for:
storing information identifying among the plurality of communication adapters installed in the system a communication adapter specified by a user as an adapter to be enabled;
determining whether said plurality of communication adapters installed in said system is available; and
enabling said communication adapter specified by the user if said communication adapter specified by the user is available.

22. A storage medium storing a program to be executed by a computer so that said computer can read the program, said program causes said computer to perform the processes for:
receiving an input event for identifying among the plurality of communication adapters installed in the system a communication adapter specified by a user as an adapter to be enabled; and
in response to said input event, enabling said communication adapter specified by the user and disabling a communication adapter that is enabled before said input event is received.
